(19) United States
(12) Patent Application Publication
(10) Pub. No.: US 2003/0208738 A1
(43) Pub. Date: Nov. 6, 2003

(54) Design method for full chip element on memory

(76) Inventors: Yu-Ming Hsu, Hsinchu (TW); Yen-Yai Lin, Hsinchu (TW); Shih-Yun Lin, Tainan (TW)

Correspondence Address: NAIPO (NORTH AMERICA INTERNATIONAL PATENT OFFICE), P.O. BOX 506, MERRIFIELD, VA, 22116, US

(21) Appl. No.: 10/063,443

(22) Filed: Apr. 24, 2002

(51) Int. Cl. G06F 17/50

(52) U.S. Cl. 716/12; 716/13; 716/16

(57) ABSTRACT

A design method for full chip element on the memory, the method splits the elements in the Hard macro into the elements with transistor level for the automation design. In the situation when there are more than 2 high voltage circuits, the method provides multiple bypass circuits as the V _{SS} and V _{DD}, wherein the V _{SS} and V _{DD} are two powers that can be recognized by the software. The multiple high voltage circuits are used as the signal circuits for routing, so that the objective of running the auto-routing on all elements in the Hard macro can be achieved. The schematic design in the Hard macro is subsequently integrated into the other part to accomplish the full chip auto placement and routing.

### BACKGROUND OF INVENTION

1. Field of Invention

The present invention generally relates to a design method for an element, and more particularly, to a design method for full chip element on the memory.

2. Description of Related Art

The commonly used design method mainly comprises both the bottom-up and top-down approaches. The bottom-up approach generally designs the important components in advance, and integrates each component into a different module, and finally joins each module to constitute the product itself. The design of the memory elements or the Mix-Mode signal integrated circuit elements generally uses the design flow of bottom-up, since the analog circuits of these elements belong to the design of the transistor level. In the prior art, the design cannot be treated as the logic gate level design, so that the elements cannot be split for the auto-routing. Whereas the top-down design method runs the component design by considering the product efficiency itself first. Besides the bottom-up and the top-down design method, it is also possible to integrate the bottom-up and the top-down design methods and use them to achieve the objective of the product optimization.

The ordinary memory is mainly composed of a memory cell array part and a logic part. Since there are a lot of analog circuits, long wires and logic parts in memory, the bottom-up design method is commonly used in designing ordinary memory. However, although it has been proposed to use the bottom-up design method in designing the logic part in memory, the analog circuit part cannot be designed by using the top-down design method. Therefore, to design the logic part by using the top-down design method cannot fulfill the requirement of the full chip automation design.

FIG. 1A and FIG. 1B schematically show a conventional memory design flow chart. The memory cell array part and the logic part are designed separately in the prior art. The design of the memory cell array part comprises the steps of a schematic design 100, a Hard macro layout 102, a full chip routing 104 and a Tape out 106.

FIG. 1B schematically shows a conventional logical design flow chart. The conventional logical design flow comprises the steps of a high level hardware description language program 110, a synthesis 112, an auto-routing 114 and a Tape out 116.

FIG. 2 schematically shows a conventional memory design flow chart. The design of the memory cell array part comprises the steps of a schematic design 200 and a Hard macro layout and function description 202. The design of the logic part comprises the steps of a high level hardware description language program 204 and a synthesis 206. The steps of the memory cell array part and the steps of the logic part are subsequently integrated and collaborated with a step of full chip routing with Hard macro 208, and finally a step of Tape out 210. Since the whole design is split into two different parts, the routing design of the analog schematic of the Hard macro is forced to use the manual method.

In the conventional memory design flow, the Hard macro in the memory cell array part that comprises a pulse generator, a capacitor, a resistor, a transistor and a high voltage element has to be designed in advance, and subsequently runs the full chip routing on it with the Hard macro. The flexibility of the routing design is largely limited by using such a method. Therefore, the whole design cannot be fully automatized, thus resulting in the phenomenon that the design time is prolonged and progress is postponed.

Moreover, the current auto placement and routing (APR) tools, such as Apollo software developed by Avanti Corp. or SE software developed by Cadence Corp., cannot run auto-routing in the situation when there are more than 2 high voltage circuits on the same chip, as is common in designing memory such as in designing the ordinary flash memory array. Therefore, in the situation when there are more than 2 high voltage circuits on the same chip, the routing is forced to use the semi-auto method.

### SUMMARY OF INVENTION

Therefore, the objective of the present invention is to provide a design method for the full chip element on memory to avoid the annoyance that the routing cannot be fully automatized caused by the Hard macro.

In order to achieve the objective mentioned above, the present invention provides a design method for full chip on memory. The method splits the elements in the Hard macro into the elements with transistor level for automation design. In the situation when there are more than 2 high voltage circuits, multiple bypass circuits are by the auto placement and routing tool as the V _{SS} and the V _{DD}, wherein the V _{SS} and the V _{DD} are two powers that can be recognized by the software. These power circuits can be used as the signal circuits for routing, so that the objective of running auto-routing on all elements in the Hard macro can be achieved. In other words, the logic gate level part and the transistor level part can run auto-routing by using the auto placement and routing tool.

After the design method of the full chip element on memory of the present invention transforms the schematic design in the Hard macro mentioned above to a format such as verilog or EDIF, it subsequently integrates it into a part other than the Hard macro (such as the logic part). After the integration, the full chip layout and the routing design as well as the full chip post-layout synthesis are processed, so that the full chip auto placement and routing can be accomplished.

In the present invention, the auto-routing method is applied on the high voltage devices, such as the N type Metal-oxide semiconductor (NMOS) transistor, P type Metal-oxide semiconductor (PMOS) transistor, and the inverter composed of the NMOS transistor and the PMOS transistor by using the cell base auto-routing method.

In the present invention, the size of the whole NMOS transistor, PMOS transistor and the inverter are defined as the integer multiple of a standard cell (depending on the software, it can also be the non-integer multiple of the standard cell), and the routing runs on these devices. Multiple bypass circuits are also provided as the V _{SS} and the V _{DD}, wherein the V _{SS} and the V _{DD} are two powers that can be recognized by the software, and their well contacts are used as the signal circuits for routing.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1A schematically shows a conventional memory design flow chart;

FIG. 1B schematically shows a conventional logical design flow chart;

FIG. 2 schematically shows a conventional memory design flow chart;

FIG. 3 schematically shows a design flow chart for the full chip element on memory of a preferred embodiment according to the present invention;

FIG. 4 schematically shows a multi-power NMOS transistor on the N type substrate in the full chip element on memory of a preferred embodiment according to the present invention;

FIG. 5 schematically shows a multi-power PMOS transistor on the N type substrate in the full chip element on memory of a preferred embodiment according to the present invention;

FIG. 6 schematically shows an inverter on the N type substrate in the full chip element on memory of a preferred embodiment according to the present invention;

FIG. 7 schematically shows a single-power NMOS transistor on the N type substrate in the full chip element on memory of a preferred embodiment according to the present invention;

FIG. 8 schematically shows a single-power PMOS transistor on the N type substrate in the full chip element on memory of a preferred embodiment according to the present invention.

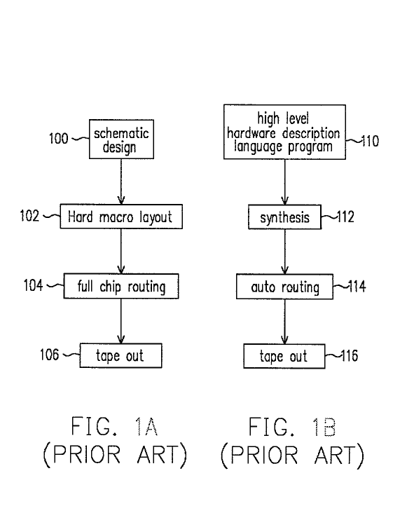

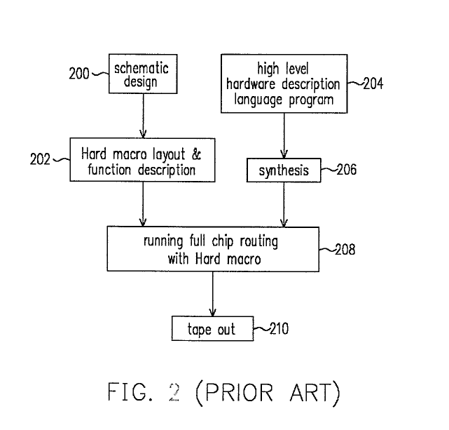

### DETAILED DESCRIPTION

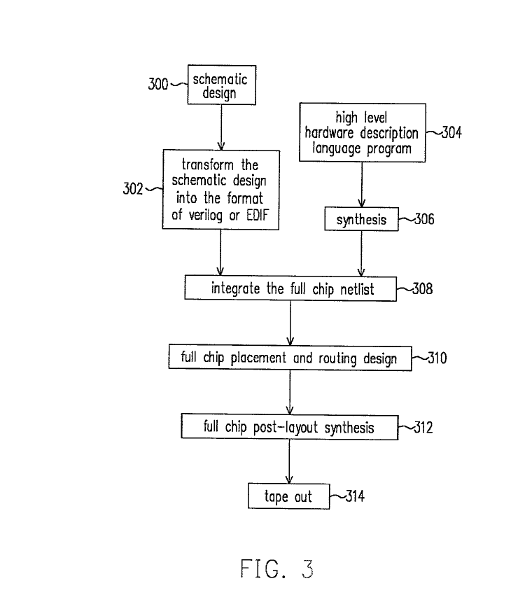

FIG. 3 schematically shows a design flow chart for the full chip element on memory of a preferred embodiment according to the present invention. In the present embodiment, the design flow of the full chip element on memory comprises the steps of a schematic design 300, converting the schematic design to the format of verilog or EDIF 302, a high level hardware description language program 304, a synthesis 306, an integrating full chip netlist 308, a full chip placement and routing schematic design 310, a full chip post-layout synthesis 312 and a Tape out 314. The design sequence is shown as in the diagram.

The Hard macro is generally composed of a pulse generator, a capacitor, a resistor, a transistor and a high voltage element. These elements are non-synthesisable in the prior art. However, the present invention simultaneously runs auto-routing on the logic gate level part, the transistor level part and other non-synthesisable circuit parts by using the auto placement and routing tool. In other words, the Hard macro is split into multiple elements with transistor level to run the automation design in the step 300 of the present embodiment. The other non-synthesisable circuit parts are designed in a similar way, the details of which are described hereinafter.

In a situation where there are more than 2 high voltage circuits on the same chip, the cell base auto-routing is used for routing. The present embodiment provides multiple bypass circuits as the V _{SS} and V _{DD} by using the auto-routing software, such as Apollo software developed by Avanti Corp. or SE software developed by Cadence Corp., wherein the V _{SS} and V _{DD} are two powers that can be recognized by the software, and uses these more than 2 high voltage circuits as the signal circuits for routing, so that the objective of running auto-routing on all elements in the Hard macro can be achieved. Using more than 2 high voltage circuits as the signal circuits for routing not only fixes the bottleneck in which the auto placement and routing tool can only recognize 2 high voltage circuits, but also runs the auto-routing on each element in the Hard macro. Although the description mentioned above uses Apollo software or SE software as an example, the present invention is not limited to only using this software.

After the design method of the full chip element on memory of the present invention transforms the schematic design in the Hard macro mentioned above to the format such as verilog or EDIF, it subsequently integrates it into the other part other than the Hard macro (such as the logic part). After the integration, the full chip layout and the routing design as well as the full chip post-layout synthesis are processed, so that the full chip auto placement and routing can be accomplished.

Furthermore, the input capacitance (input C) of the pulse generator, capacitor, resistor, transistor and high voltage element in the Hard macro, the fan-out load, the maximum capacitance and the timing information are all recorded in the .lib file.

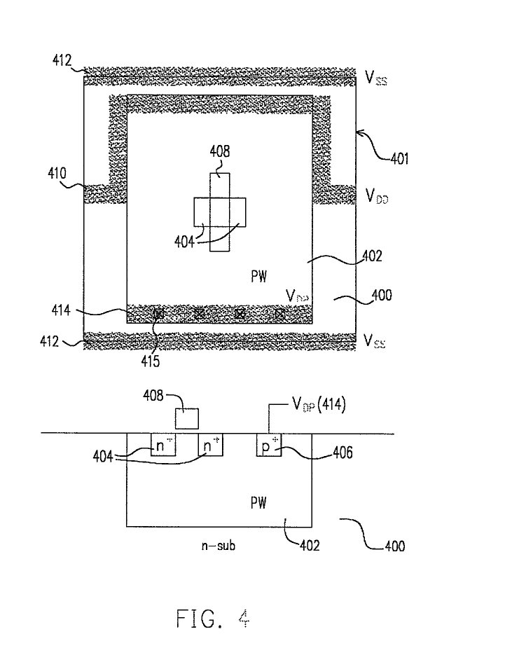

FIG. 4 schematically shows a multi-power NMOS transistor on the N type substrate in the full chip element on memory of a preferred embodiment according to the present invention. The N type substrate 400 has a P well 402 on it. There is a source/drain 404 and a well contact 406 in the P well 402 near the surface of the substrate 400. The N type substrate 400 also has a gate 408 on it.

Multiple bypass circuits 410, 412 are provided in the PR boundary 401 by using the auto placement and routing tool (APR Tool), such as Apollo software developed by Avanti Corp. or SE software developed by Cadence Corp. The circuits 410, 412 connect to the voltage such as the V _{DD} and V _{SS} respectively, wherein the V _{SS} and V _{DD} are two powers that can be recognized by the software, the high voltage circuits are used as the signal circuit 414 for routing. Wherein, the signal circuit 414 electrically couples to the well contact 406 via an insert stub 415 and the signal circuit 414 also couples to a voltage V _{DP}, so that the objective of running the auto-routing on all elements in the Hard macro can be achieved.

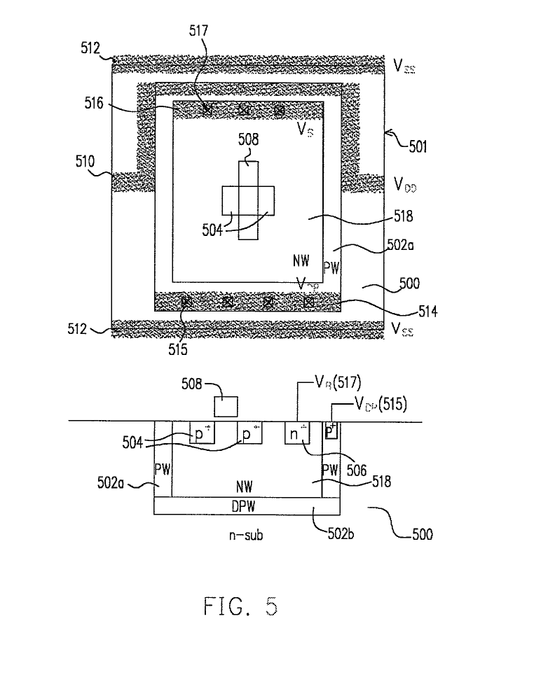

FIG. 5 schematically shows a multi-power (or separated N well) PMOS transistor on the N type substrate in the full chip element on memory of a preferred embodiment according to the present invention. The N type substrate 500 has a P well 502a and a deep P well 502b, and there is a N well 518 inside the P well 502a and the deep P well 502b. Wherein, there is a source/drain 504 and a well contact 506 in the N well 518 near the surface of the substrate 500. The N type substrate also has a gate 508 on it.

Multiple bypass circuits 510, 512 are provided in the PR boundary 501 by using the auto placement and routing tool (APR Tool), such as Apollo software developed by Avanti Corp. or SE software developed by Cadence Corp. The circuits 510, 512 connect to the voltage such as the V _{DD} and V _{SS} respectively, wherein the V _{SS} and V _{DD} are two powers that can be recognized by the software, these high voltage circuits are used as the signal circuit 514, 516 for routing. Wherein, the signal circuit 514 electrically couples to the P well 502a via an insert stub 515 and the signal circuit 514 also couples to a voltage V _{DP}; the signal circuit 516 electrically couples to the well connect 506 via an insert stub 517 and the signal circuit 516 also couples to a voltage V _{B,} so that the objective of running the auto-routing on all elements in the Hard macro can be achieved.

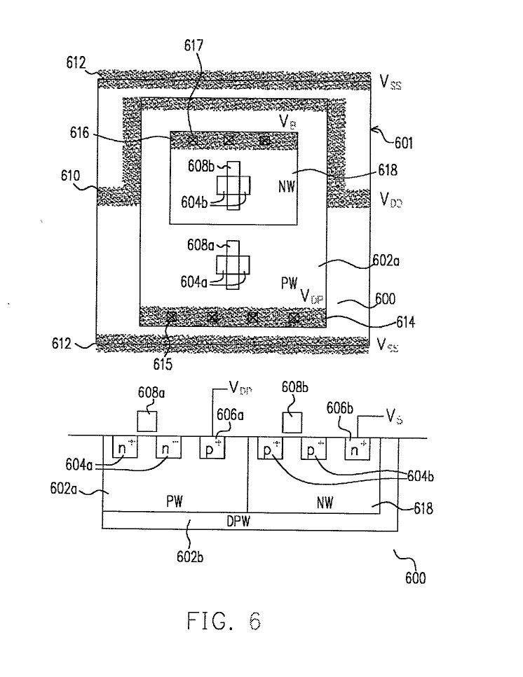

FIG. 6 schematically shows an inverter on the N type substrate in the full chip element on memory of a preferred embodiment according to the present invention. The N type substrate 600 has a P well 602a and a deep P well 602b, and there is a N well 618 inside the P well 602a and the deep P well 602b. Wherein, there is a source/drain 604a and a well contact 606a in the P well 602a near the surface of the substrate 600. The P well 602a also has a gate 608a on it. Moreover, there is a source/drain 604b and a well contact 606b in the N well 618 near the surface of the substrate 600. The N well 618 also has a gate 608b on it.

Multiple bypass circuits 610, 612 are provided in the PR boundary 601 by using the auto placement and routing tool (APR Tool), such as Apollo software developed by Avanti Corp. or SE software developed by Cadence Corp. The circuits 610, 612 connect to the voltage such as the V _{DD} and V _{SS} respectively, wherein the V _{SS} and V _{DD} are two powers that can be recognized by the software, and these high voltage circuits are used as the signal circuit 614, 616 for routing. Wherein, the signal circuit 614 electrically couples to the P well 602a via an insert stub 615 and the signal circuit 614 also couples to a voltage V _{DP}; the signal circuit 616 electrically couples to the well contact 606b via an insert stub 617 and the signal circuit 616 also couples to a voltage V _{B,} so that the objective of running the auto-routing on all elements in the Hard macro can be achieved.

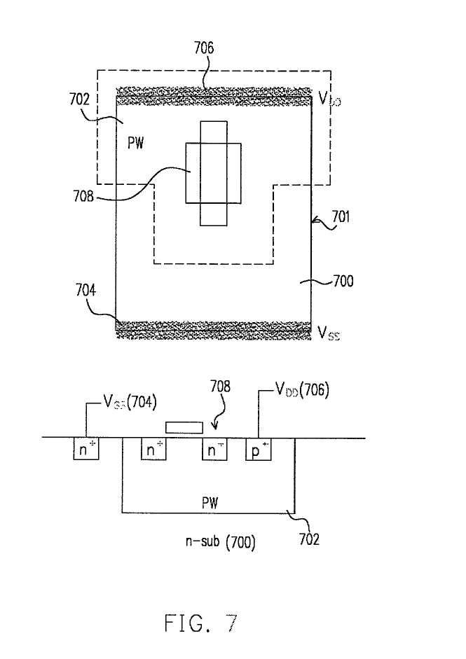

FIG. 7 schematically shows a single-power NMOS transistor on the N type substrate in the full chip element on memory of a preferred embodiment according to the present invention. The N type substrate 700 has a P well 702, and the distribution area of the P well 702 is as shown in the diagram. There is a NMOS transistor 708 in the P well 702 near the surface of the substrate 700.

Multiple bypass circuits 704, 706 are provided in the PR boundary 701 by using the auto placement and routing tool (APR Tool), such as Apollo software developed by Avanti Corp. or SE software developed by Cadence Corp. The circuits 704, 706 are placed on the edge of the PR boundary 701, the circuit 704 couples to the voltage of V _{SS}, the circuit 706 is placed on the P well 702 and electrically couples to voltage of V _{DD}. The V _{SS} and V _{DD} mentioned above are two powers that can be recognized by the software.

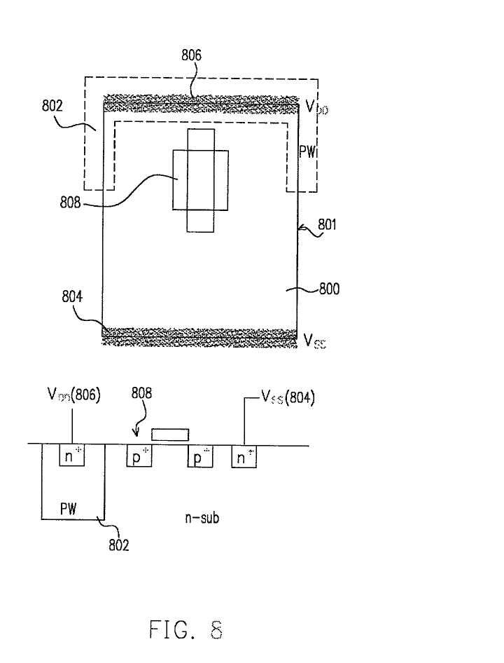

FIG. 8 schematically shows a single-power (or shared N well) PMOS transistor on the N type substrate in the full chip element on memory of a preferred embodiment according to the present invention. The N type substrate 800 has a P well 802, and the distribution area of the P well 802 is as shown in the diagram. There is a PMOS transistor 808 in the area other than the distribution area of the P well 802 near the surface of the substrate 800.

Multiple bypass circuits 804, 806 are provided in the PR boundary 801 by using the auto placement and routing tool (APR Tool), such as Apollo software developed by Avanti Corp. or SE software developed by Cadence Corp. The circuits 804, 806 are placed on the edge of the PR boundary 801, the circuit 804 couples to the voltage of V _{SS},the circuit 806 is placed on the P well 802 and electrically couples to voltage of V _{DD}. The V _{SS} and V _{DD} mentioned above are two powers that can be recognized by the software.

Although the embodiment mentioned above only uses the PMOS transistor, the NMOS transistor and the inverter on the N-type substrate as an example for description, the present invention is not limited to use such of these devices. The present invention can also be applied to the design of the elements on the P-type substrate.

In summary, the design method of the full chip element on memory according to the present invention at least comprises the advantages of

1. The design method of the full chip element on memory according to the present invention splits the Hard macro into multiple elements with transistor level for auto-routing, so that the bottleneck in which the Hard macro cannot run the auto-routing by itself can be fixed.

2. After the design method of the full chip element on memory according to the present invention providing the circuits as the V _{SS} and V _{DD}, the method further uses the high voltage circuits as the signal circuits for routing to eliminate the limitation that the auto placement and routing tool can only recognize two powers.

3. The design method of the full chip element on memory according to the present invention simultaneously runs the auto-routing on the logic gate level part, the transistor level part, and other non-synthesisable circuit part by using the auto placement and routing tool, so that the time for designing elements can be significantly reduced.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A design method for a full chip element on a memory, at least comprising:
providing an auto placement and routing software;
running an auto-routing on a logic gate level part, a transistor level part, and a non-synthesisable circuit part by using the auto placement and routing software; and
integrating the routing on the logic gate level part, the transistor level part and the non-synthesisable circuit part to achieve the objective of the full chip auto-routing.

2. The design method for the full chip element on memory of claim 1, wherein the auto-routing comprises the elements of: providing at least one bypass power node as a V _{SS} and a V _{DD}, wherein the V _{SS} and the V _{DD} are the powers that can be recognized by the auto placement and routing software.

3. The design method for the full chip element on memory of claim 2, wherein in the auto placement and routing software, assigning the plurality of high voltage nodes as a signal or a power node for auto-routing.

4. The design method for the full chip element on memory of claim 1, wherein the auto placement and routing software comprises an Apollo software and a SE software.

5. The design method for the full chip element on memory of claim 4, wherein the height of the element is an integer multiple of a standard cell in the auto placement and routing software.

6. The design method for the full chip element on memory of claim 5, wherein the plurality of bypass power nodes are placed on an edge of the standard cell.

7. The design method for the full chip element on memory of claim 4, wherein the height of the element is a multiple that is accepted by the auto placement and routing software.

8. The design method for the full chip element on memory of claim 4, wherein the multiple that is accepted by the auto placement and routing software comprises a number of 1.1 times, 1.2 times, 1.3 times and 1.4 times.

9. The design method for the full chip element on memory of claim 1, wherein the transistor level part comprises a separated N-type well PMOS transistor, a shared N-type well PMOS transistor, a separated P-type well NMOS transistor, a shared P-type well NMOS transistor and a separated well inverter.

10. The design method for the full chip element on memory of claim 1, wherein the non-synthesisable circuit part comprises a resistor, an inductor, a capacitor, a delay element, or a pulse generator.

11. A design method for a full chip element on an analog circuit, at least comprising:
providing an auto placement and routing software;
running an auto-routing on a logic gate level part, a transistor level part, and a non-synthesisable circuit part by using the auto placement and routing software; and
integrating the routing of the logic gate level part, the transistor level part and the non-synthesisable circuit part to achieve the objective of the full chip auto-routing.

12. The design method for the full chip element on memory of claim 11, wherein the auto-routing comprises the elements of: providing at least one bypass power node as a V _{SS} and a V _{DD}, wherein the V _{SS} and the V _{DD} are the powers that can be recognized by the auto placement and routing software.

13. The design method for the full chip element on memory of claim 12, wherein in the auto placement and routing software, assigning the plurality of high voltage nodes as a signal or a power node for auto-routing.

14. The design method for the full chip element on memory of claim 11, wherein the auto placement and routing software comprises an Apollo software and a SE software.

15. The design method for the full chip element on memory of claim 14, wherein the height of the element is an integer multiple of a standard cell in the auto placement and routing software.

16. The design method for the full chip element on memory of claim 15, wherein the plurality of bypass power nodes are placed on an edge of the standard cell.

17. The design method for the full chip element on memory of claim 14, wherein the height of the element is a multiple that is accepted by the auto placement and routing software.

18. The design method for the full chip element on memory of claim 14, wherein the multiple that is accepted by the auto placement and routing software comprises a number of 1.1 times, 1.2 times, 1.3 times and 1.4 times.

19. The design method for the full chip element on memory of claim 11, wherein the transistor level part comprises a single PMOS transistor of a fixed cell height layout and a single NMOS transistor of a fixed cell height layout.

20. The design method for the full chip element on memory of claim 11, wherein the non-synthesisable circuit part comprises a resistor, an inductor and a capacitor, and has a repeated and multiple height layout of a fixed height.

21. A cell body auto-routing method, suitable for running auto-routing on an element, the element comprising a plurality of power circuits, the method comprising:
providing an auto placement and routing software;
providing a plurality of bypass power nodes as a V _{SS} and a V _{DD}, wherein the V _{SS} and the V _{DD} are the powers that can be recognized by the auto placement and routing software; and
wherein in the auto placement and routing software, assigning the plurality of power circuits as a signal circuit for auto-routing.

22. The design method for the full chip element on memory of claim 21, wherein the auto placement and routing software comprises an Apollo software and a SE software.

23. The design method for the full chip element on memory of claim 22, wherein the height of the element is an integer multiple of a standard cell in the auto placement and routing software.

24. The design method for the full chip element on memory of claim 23, wherein the plurality of bypass circuits are placed on an edge of the standard cell.

25. The design method for the full chip element on memory of claim 22, wherein the height of the element is a multiple that is accepted by the auto placement and routing software.

26. The design method for the full chip element on memory of claim 22, wherein the multiple that is accepted by the auto placement and routing software comprises a number of 1.1 times, 1.2 times, 1.3 times and 1.4 times.

27. The design method for the full chip element on memory of claim 21, wherein the transistor level part comprises a separated N-type well PMOS transistor, a shared N-type well PMOS transistor, a separated P-type well NMOS transistor, a shared P-type well NMOS transistor and a separated well inverter.

28. The design method for the full chip element on memory of claim 21, wherein the non-synthesisable circuit part comprises a resistor, an inductor, a capacitor, a delay element or a pulse generator, and has a repeated and multiple height layout of a fixed height.
